(19) United States
(12) Patent Application Publication
(10) Pub. No.: US 2025/0093741 A1
(43) Pub. Date: Mar. 20, 2025

(54) OPTICAL UNIT

(71) Applicant: NIDEC INSTRUMENTS CORPORATION, Nagano (JP)

(72) Inventor: Shinji MINAMISAWA, Nagano (JP)

(73) Assignee: NIDEC INSTRUMENTS CORPORATION, Nagano (JP)

(21) Appl. No.: 18/826,132

(22) Filed: Sep. 5, 2024

(30) Foreign Application Priority Data
Sep. 14, 2023 (JP) 2023-149251

(51) Int. Cl. G03B 5/00; H04M 1/02

(52) U.S. Cl. CPC G03B 5/00; G03B 2205/0069; H04M 1/0264

(57) ABSTRACT

An optical unit includes a movable body having an optical module, a fixed body which holds the movable body, and a drive mechanism for turning the movable body with respect to the fixed body so that an optical axis of the optical module is inclined. The drive mechanism includes a drive magnet attached to the movable body and a drive coil attached to the fixed body. The drive magnet and the drive coil face each other in a direction perpendicular to an optical axis direction of the optical module when the optical module is located at a predetermined reference position. The drive magnet is magnetized in the optical axis direction, and a magnetic pole of one face of the drive magnet in the optical axis direction and a magnetic pole of the other face of the drive magnet in the optical axis direction are different from each other.

### CROSS REFERENCE TO RELATED APPLICATION

The present invention claims priority under 35 U.S.C. § 119 to Japanese Application No. 2023-149251 filed Sep. 14, 2023, the entire content of which is incorporated herein by reference.

### FIELD OF THE INVENTION

At least an embodiment of the present disclosure may relate to an optical unit which is mounted on a portable device or the like.

### BACKGROUND

Conventionally, an optical unit which is mounted on a smartphone or the like has been known. A conventional optical unit includes a first movable body having a camera module which is an optical module, a gimbal mechanism which turnably supports the first movable body, a second movable body which supports the first movable body through the gimbal mechanism, and a swing mechanism which swings the first movable body with respect to the second movable body. Further, the optical unit includes a fixed body which holds the first movable body and the second movable body in its inside.

In the optical unit described above, the swing mechanism includes a drive magnet fixed to the first movable body and a drive coil fixed to the second movable body. The drive magnet is magnetized in a direction perpendicular to an optical axis direction which is a direction of an optical axis of a camera module. Further, the drive magnet is two-pole magnetized so that an “N”-pole and an “S”-pole are formed side by side in the optical axis direction. The drive coil is disposed so as to face the drive magnet in a direction perpendicular to the optical axis direction.

The present inventor has developed an optical unit 100 (see FIGS. 6A and 6B) which includes a movable body 101 having an optical module such as a camera module, a fixed body 102 which holds the movable body 101, and a drive mechanism 103 for turning the movable body 101 with respect to the fixed body 102 so that an optical axis “L10” of the optical module is inclined. The drive mechanism 103 includes a drive magnet 105 attached to the movable body 101 and a drive coil 106 attached to the fixed body 102. The drive coil 106 is, for example, an air-core coil which is defined by winding a conductor in an air core shape. The drive magnet 105 and the drive coil 106 face each other in a direction perpendicular to an optical axis direction which is a direction of the optical axis “L10” of the optical module when the optical module is located at a predetermined reference position where the optical axis “L10” of the optical module does not incline (see FIG. 6A).

When a direction in which the drive magnet 105 and the drive coil 106 face each other in a state that the optical module is located at the reference position is defined as a facing direction, the present inventor has examined a structure that, similarly to the optical unit described above, the drive magnet 105 is magnetized in the facing direction and is two-pole magnetized so that an “N”-pole and an “S”-pole are disposed side by side in the optical axis direction in an optical unit 100 under development. The movable body 101 is turnable with respect to the fixed body 102 with a direction perpendicular to the optical axis direction and the facing direction as an axial direction of turning and is turnable with respect to the fixed body 102 with a turning center “C10” as a center.

As shown in FIGS. 6A and 6B, in a case that one side part in the optical axis direction of the drive magnet 105 which is two-poles magnetized is referred to as a first magnet part 105a, the other side part in the optical axis direction of the drive magnet 105 is referred to as a second magnet part 105b, an effective side on one side in the optical axis direction of the drive coil 106 wound around in an air core shape is referred to as a first coil part 106a, and an effective side on the other side in the optical axis direction of the drive coil 106 is referred to as a second coil part 106b, when the optical module is located at the reference position, as shown in FIG. 6A, generally, a magnetic flux passing through the first coil part 106a is generated from the first magnet part 105a, and a magnetic flux passing through the second coil part 106b is generated from the second magnet part 105b.

Therefore, in a case that the optical module is located at the reference position, when an electric current is supplied to the drive coil 106, for example, as shown in FIG. 6A, an electromagnetic force is approximately generated in a direction shown by the arrow “V11” on one side in the optical axis direction, and an electromagnetic force is approximately generated in a direction shown by the arrow “V12” on the other side in the optical axis direction. Both of the electromagnetic force generated on one side in the optical axis direction and the electromagnetic force generated on the other side in the optical axis direction are electromagnetic forces which act in directions where the movable body 101 is desired to be turned with respect to the fixed body 102.

On the other hand, in the optical unit 100, when a turning angle of the movable body 101 is increased with respect to the fixed body 102 for largely inclining the optical axis “L10” (for example, when the optical axis “L10” of the optical module located at the reference position is inclined at about 5° (degree)), the present inventor has found that, as shown in FIG. 6B, a part of magnetic flux going from the first magnet part 105a to the second magnet part 105b may pass through the first coil part 106a. In a case that a part of the magnetic flux going from the first magnet part 105a to the second magnet part 105b passes through the first coil part 106a, when an electric current is supplied to the drive coil 106, an electromagnetic force is approximately generated in a direction shown by the arrow “V13” on one side in the optical axis direction, an electromagnetic force is approximately generated in a direction shown by the arrow “V14” on the other side in the optical axis direction, and an electromagnetic force is approximately generated in a direction shown by the arrow “V15” on the one side in the optical axis direction.

The electromagnetic force in a direction shown by the arrow “V13” and the electromagnetic force in a direction shown by the arrow “V14” are electromagnetic forces which act in a direction that is desired to turn the movable body 101 with respect to the fixed body 102. However, the electromagnetic force in a direction shown by the arrow “V15” is an electromagnetic force which acts in an opposite direction to the direction that is desired to turn the movable body 101 with respect to the fixed body 102. Therefore, in the optical unit 100, when a turning angle of the movable body 101 with respect to the fixed body 102 is increased, a drive force of the drive mechanism 103 may decrease.

Even when a turning angle of the movable body 101 with respect to the fixed body 102 is increased, if an inside diameter of the drive coil 106 is set to be large, it may be prevented that a part of the magnetic flux going from the first magnet part 105a to the second magnet part 105b passes through the first coil part 106a. Therefore, even when a turning angle of the movable body 101 with respect to the fixed body 102 is increased, a decrease of a drive force of the drive mechanism 103 is able to be suppressed. However, in this case, a size of the drive coil 106 is increased in the optical axis direction and thus, a size of the optical unit 100 may be increased in the optical axis direction.

### SUMMARY

According to at least an embodiment of the present disclosure, there may be provided an optical unit including a movable body having an optical module, a fixed body which holds the movable body, and a drive mechanism for turning the movable body with respect to the fixed body so that an optical axis of the optical module is inclined. The drive mechanism includes a drive magnet which is attached to the movable body and a drive coil which is attached to the fixed body, and the drive magnet and the drive coil face each other in a direction perpendicular to an optical axis direction which is a direction of the optical axis of the optical module when the optical module is located at a predetermined reference position. The drive magnet is magnetized in the optical axis direction, and a magnetic pole of one of faces of the drive magnet in the optical axis direction and a magnetic pole of the other of the faces of the drive magnet in the optical axis direction are different from each other.

The above and other elements, features, steps, characteristics and advantages of the present disclosure will become more apparent from the following detailed description of the preferred embodiments with reference to the attached drawings

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic plan view for explaining a structure of an optical unit in accordance with an embodiment of the present disclosure.

FIG. 2 is a schematic side view for explaining the structure of the optical unit shown in FIG. 1.

FIGS. 3A and 3B are schematic views for explaining a structure of a drive mechanism shown in FIG. 1. FIG. 3A is a view showing a state that an optical module is located at a reference position, and FIG. 3B is a view showing a state that an optical axis of the optical module is largely inclined.

FIG. 4 is a graph showing a simulation result for explaining an effect of the optical unit shown in FIG. 1.

FIG. 5 is a graph showing a simulation result for explaining an effect of the optical unit shown in FIG. 1.

FIGS. 6A and 6B are schematic views for explaining a problem of a prior art. FIG. 6A is a view showing a state that an optical module is located at a reference position, and FIG. 6B is a view showing a state that an optical axis of the optical module is largely inclined.

### DETAILED DESCRIPTION

In the optical unit in accordance with at least an embodiment of the present disclosure, the drive magnet is magnetized in the optical axis direction, and a magnetic pole of one of faces of the drive magnet and a magnetic pole of the other of the drive magnet are different from each other. Therefore, according to the examinations of the present inventor, in the embodiment of the present disclosure, for example, even when an inner diameter of the drive coil which is wound around in an air core shape is set to be small and thereby the drive coil is miniaturized in the optical axis direction and, further, even when a turning angle of the movable body with respect to the fixed body becomes large, an electromagnetic force acting in an opposite direction to a direction where the movable body is desired to turn with respect to the fixed body can be prevented from generating between the drive magnet and the drive coil. Accordingly, in the present disclosure, even when a turning angle of the movable body with respect to the fixed body becomes large, the optical unit is able to be miniaturized in the optical axis direction of the optical module while securing a drive force of the drive mechanism.

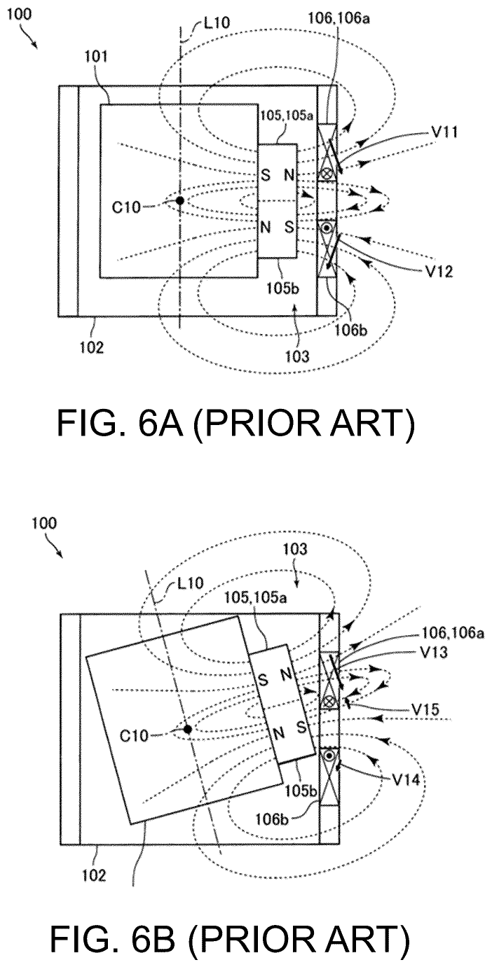

Further, in the present disclosure, the drive magnet is magnetized in the optical axis direction and thus, in comparison with a case that a drive magnet is two-pole magnetized in the optical axis direction like the drive magnet 105 shown in FIGS. 6A and 6B, the drive magnet is able to be easily manufactured. Therefore, according to the present disclosure, a manufacturing cost of the drive magnet is able to be reduced.

In the present disclosure, for example, in a case that a predetermined direction perpendicular to the optical axis direction when the optical module is located at the reference position is defined as a first direction, and a direction perpendicular to the optical axis direction and the first direction when the optical module is located at the reference position is referred to as a second direction, the drive mechanism includes, as the drive magnet, a first drive magnet for turning the movable body with respect to the fixed body with the first direction as an axial direction of turning, and a second drive magnet for turning the movable body with respect to the fixed body with the second direction as an axial direction of turning and, as the drive coil, a first drive coil which is disposed so as to face the first drive magnet in the second direction, and a second drive coil which is disposed so as to face the second drive magnet in the first direction.

In the present disclosure, the optical unit includes, for example, an intermediate member which turnably holds the movable body, and the fixed body turnably holds the intermediate member. Further, in the present disclosure, for example, the optical module is a camera module.

In the present disclosure, for example, in a case that a direction in which the drive magnet and the drive coil face each other when the optical module is located at the reference position is defined as a facing direction, when viewed in the facing direction in a state that the optical module is located at the reference position, a center of the drive magnet and a center of the drive coil are coincided with each other. In this case, balance of drive forces of the drive mechanism is improved.

In the present disclosure, it is preferable that a width of the drive magnet in the optical axis direction is smaller than a width of the drive coil in the optical axis direction when the optical module is located at the reference position. According to the examinations of the present inventor, in the above-mentioned structure, even when the drive magnet is magnetized in the optical axis direction, density of magnetic flux passing through the drive coil is able to be increased in a state that the camera module is located at a reference position. Therefore, even when the drive magnet is magnetized in the optical axis direction, a drive force of the drive mechanism when the camera module is located at a reference position is able to be secured.

In the present disclosure, it is preferable that, in a case that a direction in which the drive magnet and the drive coil face each other when the optical module is located at the reference position is defined as a facing direction, a thickness of the drive magnet in the facing direction when the optical module is located at the reference position is larger than a thickness of the drive coil in the facing direction. According to this structure, even when a drive magnet is magnetized in the optical axis direction, density of magnetic flux passing through the drive coil is able to be increased. Therefore, a drive force of the drive mechanism is able to be increased.

In the present disclosure, it is preferable that the movable body includes a holder made of resin to which the optical module is fixed, and the drive magnet is directly fixed to the holder. According to this structure, in comparison with a case that the drive magnet is fixed to the holder through a back yoke (in other words, in comparison with a case that a back yoke is disposed between the drive magnet and the holder), density of magnetic flux passing through the drive coil is able to be increased. Therefore, a drive force of the drive mechanism is able to be increased.

An embodiment of the present disclosure will be described below with reference to the accompanying drawings.

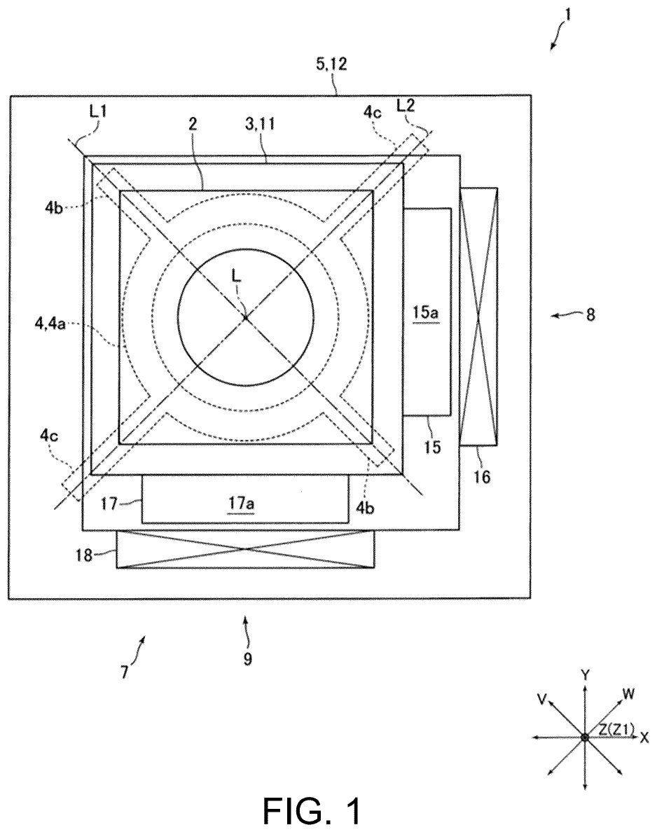

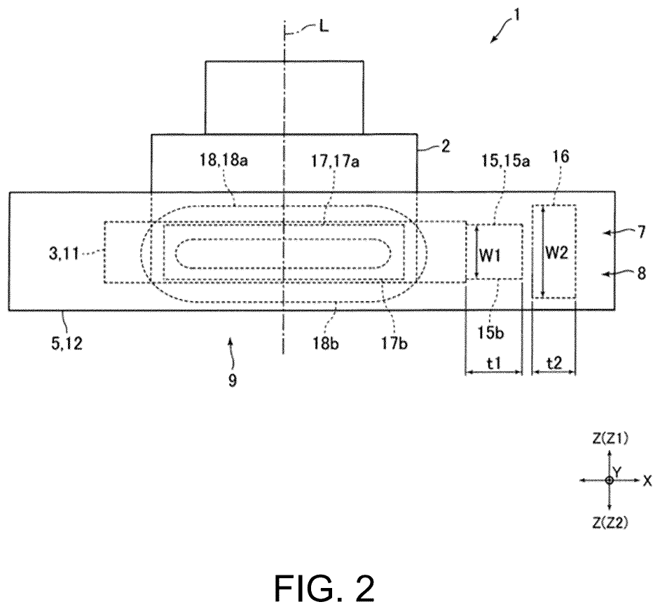

FIG. 1 is a schematic plan view for explaining a structure of an optical unit 1 in accordance with an embodiment of the present disclosure. FIG. 2 is a schematic side view for explaining the structure of the optical unit 1 shown in FIG. 1. In the following descriptions, as shown in FIG. 1 and the like, three directions perpendicular to each other are respectively defined as an “X”-direction, a “Y”-direction and a “Z”-direction. The “X”-direction is a right and left direction, the “Y”-direction is a front and rear direction, and the “Z”-direction is an upper and lower direction. Further, the Z1 direction side in FIG. 2 and the like which is one side in the upper and lower direction is referred to as an “upper” side, and the Z2 direction side in FIG. 2 and the like which is the opposite side is referred to as a “lower” side.

An optical unit 1 in this embodiment is, for example, a small and thin unit which is mounted on a portable device such as a smartphone. The optical unit 1 includes, as an optical module, a camera module 2 having a lens for capturing images and an imaging element. Further, the optical unit 1 is provided with a shake correction function for avoiding disturbance of a captured image due to a shake in image capturing. The optical unit 1 is, as a whole, provided in a flat rectangular parallelepiped shape whose thickness is thin. The optical unit 1 in this embodiment is provided so that its shape when viewed in an optical axis direction which is a direction of an optical axis “L” of the camera module 2 is a rectangular shape close to a square. Four side faces of the optical unit 1 are parallel to the “Z-X” plane defined by a right and left direction and an upper and lower direction and the “Y-Z” plane defined by a front and rear direction and the upper and lower direction.

The optical unit 1 includes a movable body 3 having the camera module 2, an intermediate member 4 which turnably holds the movable body 3, and a fixed body 5 which turnably holds the intermediate member 4. The movable body 3 is turnable with respect to the intermediate member 4 with a first intersection direction which intersects the optical axis “L” of the camera module 2 (“V”-direction in FIG. 1) as an axial direction of turning. In other words, the movable body 3 is turnable with respect to the intermediate member 4 with the first axial line “L1” (see FIG. 1) whose axial line direction is the first intersection direction as a turning center. The first intersection direction in this embodiment is perpendicular to the optical axis “L”. In FIG. 2, the intermediate member 4 is not shown.

The intermediate member 4 is turnable with respect to the fixed body 5 with a second intersection direction (“W”-direction in FIG. 1) which intersects the first intersection direction and intersects the optical axis “L” of the camera module 2 as an axial direction of turning. In other words, the intermediate member 4 is turnable with respect to the fixed body 5 with the second axial line “L2” (see FIG. 1) whose an axial line direction is the second intersection direction as a turning center. In this embodiment, the second intersection direction is perpendicular to the first intersection direction. As described above, two-axes gimbal mechanism is structured between the movable body 3 and the fixed body 5.

In this embodiment, when an electric current is not supplied to a drive coil 16 and a drive coil 18 described below, the camera module 2 is located at a predetermined reference position. When the camera module 2 is located at a reference position, an optical axis direction of the camera module 2 is coincided with the upper and lower direction. A front and rear direction (“Y”-direction) in this embodiment is a first direction which is a predetermined direction perpendicular to the optical axis direction (upper and lower direction) when the camera module 2 is located at the reference position, and a right and left direction (“X”-direction) is a second direction which is a direction perpendicular to the optical axis direction (upper and lower direction) and the first direction (front and rear direction) when the camera module 2 is located at the reference position.

In this embodiment, when a shake correction is performed in the optical unit 1, an inclination of the optical axis “L” of the camera module 2 with respect to the upper and lower direction is about 5° at the maximum, and a turning angle of the movable body 3 with respect to the fixed body 5 is relatively large. However, when a shake correction is performed in the optical unit 1, an inclination of the optical axis “L” with respect to the upper and lower direction is about 5° at the maximum and thus, the optical axis direction of the camera module 2 is approximately coincided with the upper and lower direction.

Further, when the camera module 2 is located at the reference position, the second intersection direction (“W”-direction) is perpendicular to the optical axis “L”. In other words, when the camera module 2 is located at the reference position and the movable body 3 is not turned with respect to the intermediate member 4, the second intersection direction is perpendicular to the optical axis “L”. On the other hand, when the movable body 3 is turned with respect to the intermediate member 4, although the second intersection direction intersects the optical axis “L”, the second intersection direction does not intersect the optical axis “L” at a right angle.

The optical unit 1 includes a drive mechanism 7 for turning the movable body 3 with respect to the fixed body 5 so that the optical axis “L” of the camera module 2 is inclined. The drive mechanism 7 includes a first drive mechanism 8 for turning the movable body 3 with respect to the fixed body 5 with the front and rear direction as an axial direction of turning, and a second drive mechanism 9 for turning the movable body 3 with respect to the fixed body 5 with the right and left direction as an axial direction of turning. The drive mechanism 7 turns the movable body 3 with respect to the fixed body 5 so that the optical axis “L” of the camera module 2 is inclined in an arbitrary direction.

The movable body 3 includes a holder 11 made of resin to which the camera module 2 is fixed. The holder 11 is provided in a flat rectangular tube shape whose both ends in the optical axis direction are opened. An outside shape of the holder 11 when viewed in the optical axis direction is a square shape. Further, when the camera module 2 is located at the reference position, two of four sides structuring an outer peripheral face of the holder 11 whose outside shape is a square shape are parallel to the front and rear direction, and the remaining two sides are parallel to the right and left direction.

The camera module 2 is fixed to an inner peripheral face of the holder 11. The holder 11 covers a lower end part of the camera module 2 from an outer peripheral side. As described above, the camera module 2 includes a lens and an imaging element. The imaging element is disposed on a lower end side of the camera module 2, and a subject located on an upper side with respect to the camera module 2 is captured by the camera module 2.

As described above, an inclination of the optical axis “L” of the camera module 2 with respect to the upper and lower direction when a shake correction is performed in the optical unit 1 is about 5° at the maximum, and the optical axis direction of the camera module 2 is approximately coincided with the upper and lower direction. Therefore, when one side in the optical axis direction (specifically, a side where a subject is located in the optical axis direction) is referred to as a subject side, and an opposite side to the subject side (specifically, a side where the imaging element is disposed in the optical axis direction) is referred to as an anti-subject side, the subject side is substantially coincided with an upper side and the anti-subject side is substantially coincided with a lower side.

The intermediate member 4 is a plate spring which is defined by bending a metal plate having a spring property in a predetermined shape. The intermediate member 4 is structured of a base part 4a, two first arm parts 4b which are extended from the base part 4a toward both sides in the first intersection direction, and two second arm parts 4c which are extended from the base part 4a toward both sides in the second intersection direction.

An outer side in the first intersection direction of the first arm part 4b is disposed with a first fulcrum part (not shown) which serves as a fulcrum of turning of the movable body 3 with respect to the intermediate member 4. An outer side in the second intersection direction of the second arm part 4c is disposed with a second fulcrum part (not shown) which serves as a fulcrum of turning of the intermediate member 4 with respect to the fixed body 5. The first fulcrum part includes, for example, a support member which is made of metal and is fixed to the holder 11, and a spherical body which is disposed between the first arm part 4b and the support member. The second fulcrum part includes, for example, a support member fixed to a case body 12 which structures a part of the fixed body 5 as described below, and a spherical body which is disposed between the second arm part 4c and the support member.

The fixed body 5 holds the movable body 3 through the intermediate member 4. The fixed body 5 includes the case body 12 in a frame shape which is made of resin and is disposed on an outer peripheral side with respect to the movable body 3 and the intermediate member 4. The intermediate member 4 is turnably held by the case body 12. The case body 12 is provided in a flat rectangular tube shape whose both ends in the upper and lower direction are opened. A shape of the case body 12 when viewed in the upper and lower direction is a square frame shape. When viewed in the upper and lower direction, two of four sides structuring an outer peripheral face of the case body 12 whose outside shape is a square shape are parallel to the front and rear direction, and the remaining two sides are parallel to the right and left direction. The case body 12 is disposed on an outer peripheral side with respect to the holder 11.

In the optical unit 1, when a change in an inclination of the movable body 3 is detected by a predetermined detection mechanism for detecting a change in an inclination of the movable body 3, an electric current is supplied to at least one of a drive coil 16 and a drive coil 18 based on a detection result of the detection mechanism and the shake is corrected.

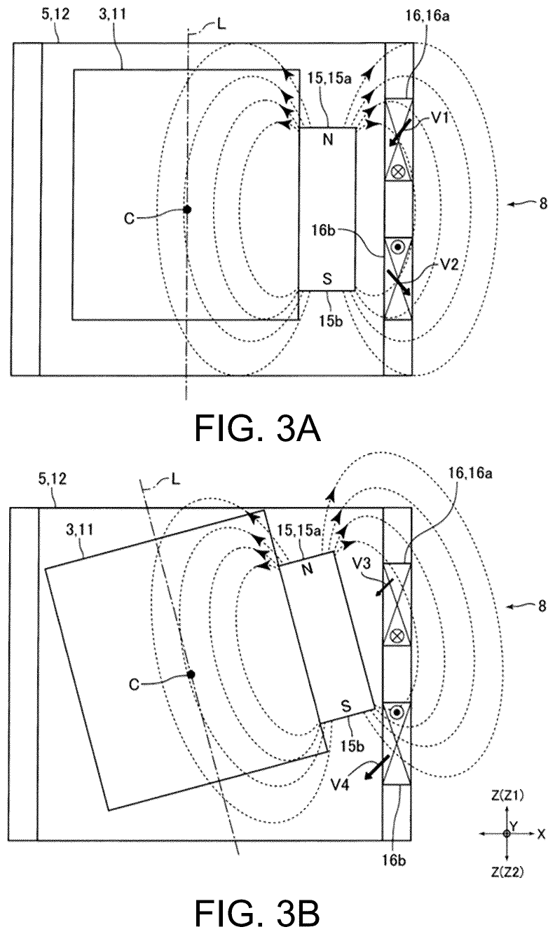

FIGS. 3A and 3B are schematic views for explaining a structure of the first drive mechanism 8 shown in FIG. 1. FIG. 3A is a view showing a state that the camera module 2 is located at the reference position, and FIG. 3B is a view showing a state that the optical axis “L” of the camera module 2 is largely inclined.

The drive mechanism 7 includes, as described above, the first drive mechanism 8 and the second drive mechanism 9. The first drive mechanism 8 includes a drive magnet 15 as a first drive magnet which is attached to the movable body 3, and a drive coil 16 as a first drive coil which is attached to the fixed body 5. The second drive mechanism 9 includes a drive magnet 17 as a second drive magnet which is attached to the movable body 3, and a drive coil 18 as a second drive coil which is attached to the fixed body 5. The drive magnets 15 and 17 and the drive coils 16 and 18 are disposed on a lower side with respect to a center in the upper and lower direction of the optical unit 1.

When the camera module 2 is located at the reference position, the drive magnet 15 and the drive coil 16 face each other in the right and left direction which is perpendicular to the optical axis direction, and the drive magnet 17 and the drive coil 18 face each other in the front and rear direction perpendicular to the optical axis direction. In this embodiment, in the first drive mechanism 8, the right and left direction (“X”-direction) is a facing direction where the drive magnet 15 and the drive coil 16 face each other when the camera module 2 is located at the reference position. Further, in the second drive mechanism 9, the front and rear direction (“Y”-direction) is a facing direction where the drive magnet 17 and the drive coil 18 face each other when the camera module 2 is located at the reference position.

The drive magnet 15 is a permanent magnet which is provided in a rectangular solid shape. The drive magnet 15 is fixed to the holder 11. Specifically, the drive magnet 15 is fixed to one of side faces in the right and left direction of the holder 11. Further, the drive magnet 15 is directly fixed to a side face of the holder 11. In other words, a back yoke is not disposed between a side face of the drive magnet 15 and a side face of the holder 11, and the side face of the drive magnet 15 is directly contacted with the side face of the holder 11.

An upper face and a lower face of the drive magnet 15 are faces which are perpendicular to the optical axis direction. A width in the front and rear direction of the drive magnet 15 is wider than a width in the optical axis direction of the drive magnet 15. The drive magnet 15 is provided in a rectangular solid shape which is long and thin in the front and rear direction. The drive magnet 15 is magnetized in the optical axis direction, and a magnetic pole of a face on the subject side (hereinafter, referred to as a “subject side face 15a”) of the drive magnet 15 is different from a magnetic pole of a face on an anti-subject side (hereinafter, referred to as an “anti-subject side face 15b”) of the drive magnet 15. For example, as shown in FIGS. 3A and 3B, a magnetic pole of the subject side face 15a is an “N”-pole, and a magnetic pole of the anti-subject side face 15b is an “S”-pole. As described above, the drive magnet 15 is single-pole magnetized in the optical axis direction.

The drive coil 16 is fixed to the case body 12. The drive coil 16 is disposed on one side in the right and left direction with respect to the drive magnet 15 and is arranged so as to face the drive magnet 15 in the right and left direction. The drive coil 16 is, for example, an air-core coil which is defined by winding a conducting wire in an air core shape. The drive coil 16 is provided with two effective side parts 16a and 16b which are parallel to the front and rear direction (see FIGS. 3A and 3B). The effective side part 16a is disposed on an upper side with respect to the effective side part 16b. An inside diameter of the drive coil 16 is relatively small, and an interval in the upper and lower direction between the effective side part 16a and the effective side part 16b is relatively narrow. A Hall IC (not shown) is disposed on an inner peripheral side of the drive coil 16 for detecting a position of the movable body 3.

In a case that the camera module 2 is located at the reference position, when viewed in the right and left direction, a center of the drive magnet 15 and a center of the drive coil 16 are coincided with each other. As shown in FIG. 2, a width “W1” in the optical axis direction of the drive magnet 15 is smaller than a width “W2” in the upper and lower direction of the drive coil 16. In other words, the width “W1” of the drive magnet 15 in the optical axis direction is smaller than the width “W2” of the drive coil 16 in the optical axis direction when the camera module 2 is located at the reference position. Further, when the camera module 2 is located at the reference position, a thickness “t1” in the right and left direction of the drive magnet 15 is set to be larger than a thickness “t2” in the right and left direction of the drive coil 16.

The drive magnet 17 is a permanent magnet which is provided in the same shape as the drive magnet 15. The drive magnet 17 is fixed to one of side faces in the front and rear direction of the holder 11. Further, the drive magnet 17 is directly fixed to the side face of the holder 11. The drive magnet 17 is disposed at the same position as the drive magnet 15 in the upper and lower direction. Similarly to the drive magnet 15, the drive magnet 17 is magnetized in the optical axis direction, and a magnetic pole of a face on the subject side (hereinafter, referred to as a “subject side face 17a”) of the drive magnet 17 is different from a magnetic pole of a face on the anti-subject side (hereinafter, referred to as an “anti-subject side face 17b”) of the drive magnet 17. For example, a magnetic pole of the subject side face 17a is an “N”-pole, and a magnetic pole of the anti-subject side face 17b is an “S”-pole.

The drive coil 18 is fixed to the case body 12. The drive coil 18 is disposed on one side in the front and rear direction with respect to the drive magnet 17 and is arranged so as to face the drive magnet 17 in the front and rear direction. The drive coil 18 is provided in the same shape as the drive coil 16. The drive coil 18 is provided with two effective side parts 18a and 18b which are parallel to the right and left direction (see FIG. 2). The effective side part 18a is disposed on an upper side with respect to the effective side part 18b. A Hall IC (not shown) is disposed on an inner peripheral side of the drive coil 18 for detecting a position of the movable body 3.

In a case that the camera module 2 is located at the reference position, when viewed in the front and rear direction, a center of the drive magnet 17 and a center of the drive coil 18 are coincided with each other. A width in the optical axis direction of the drive magnet 17 is smaller than a width in the upper and lower direction of the drive coil 18. Further, when the camera module 2 is located at the reference position, a thickness in the front and rear direction of the drive magnet 17 is set to be larger than a thickness in the front and rear direction of the drive coil 18.

When the camera module 2 is located at the reference position, for example, a magnetic flux generated from the drive magnet 15 passes through the drive coil 16 as shown in FIG. 3A. Therefore, in a state that the camera module 2 is located at the reference position, when an electric current is supplied to the drive coil 16, for example, as shown in FIG. 3A, an electromagnetic force is generated in a direction approximately as shown by the arrow “V1” on an upper side of the first drive mechanism 8, and an electromagnetic force is generated in a direction approximately as shown by the arrow “V2” on a lower side of the first drive mechanism 8. Both of the electromagnetic force in a direction as shown by the arrow “V1” and the electromagnetic force in a direction as shown by the arrow “V2” are electromagnetic forces which act in directions that the movable body 3 is desired to turn with respect to the fixed body 5. In this embodiment, when an electric current is supplied to the drive coil 16, the movable body 3 is turned with respect to the fixed body 5 with a turning center “C” as a center.

Further, when the movable body 3 is turned with respect to the fixed body 5 with the front and rear direction as an axial direction of turning to make the optical axis “L” of the camera module 2 incline largely (for example, when the optical axis “L” of the camera module 2 located at the reference position is inclined by about 5°), the magnetic flux generated from the drive magnet 15 passes through the drive coil 16, for example, as shown in FIG. 3B. Therefore, in a state that the optical axis “L” of the camera module 2 is inclined largely, when an electric current is supplied to the drive coil 16, for example, as shown in FIG. 3B, an electromagnetic force is generated approximately in a direction as shown by the arrow “V3” on an upper side of the first drive mechanism 8 and, on a lower side of the first drive mechanism 8, an electromagnetic force is generated approximately in a direction as shown by the arrow “V4”.

Both of the electromagnetic force in a direction as shown by the arrow “V3” and the electromagnetic force in a direction as shown by the arrow “V4” are electromagnetic forces which act in a direction where the movable body 3 is desired to turn with respect to the fixed body 5. Further, when the optical axis “L” of the camera module 2 is inclined largely with the front and rear direction as an axial direction of turning, for example, as shown in FIG. 3B, an interval between the anti-subject side face 15b and the effective side part 16b is made smaller and thus, an electromagnetic force generated on a lower side of the first drive mechanism 8 becomes large. Alternatively, when the optical axis “L” of the camera module 2 is inclined largely with the front and rear direction as an axial direction of turning, an interval between the subject side face 15a and the effective side part 16a is made smaller and thus, an electromagnetic force generated on an upper side of the first drive mechanism 8 becomes large.

Similarly, also in the second drive mechanism 9, in a state that the camera module 2 is located at the reference position, when an electric current is supplied to the drive coil 18, electromagnetic forces are generated on both of an upper side and a lower side of the second drive mechanism 9 in directions where the movable body 3 is desired to turn with respect to the fixed body 5. Further, even when the movable body 3 is turned with respect to the fixed body 5 with the right and left direction as an axial direction of turning to make the optical axis “L” of the camera module 2 incline largely, electromagnetic forces are generated in directions where the movable body 3 is desired to turn with respect to the fixed body 5 on both of an upper side and a lower side of the second drive mechanism 9.

Further, when the optical axis “L” of the camera module 2 is inclined largely with the right and left direction as an axial direction of turning, for example, an interval between the subject side face 17a and the effective side part 18a is made smaller and thus, an electromagnetic force generated on an upper side of the second drive mechanism 9 becomes large. Alternatively, when the optical axis “L” of the camera module 2 is inclined largely with the right and left direction as an axial direction of turning, an interval between the anti-subject side face 17b and the effective side part 18b is made smaller and thus, an electromagnetic force generated on a lower side of the second drive mechanism 9 becomes large.

As described above, in this embodiment, the drive magnet 15 is magnetized in the optical axis direction, and a magnetic pole of the subject side face 15a and a magnetic pole of the anti-subject side face 15b of the drive magnet 15 are different from each other. Therefore, according to this embodiment, even when an inner diameter of the drive coil 16 which is wound around in an air core shape is set to be small and thereby the drive coil 16 is miniaturized in the optical axis direction and, further, even when a turning angle of the movable body 3 with respect to the fixed body 5 with the front and rear direction as an axial direction of turning is large, it is possible to prevent an electromagnetic force acting in an opposite direction to a direction where the movable body 3 is desired to turn with respect to the fixed body 5 from generating between the drive magnet 15 and the drive coil 16.

Similarly, in this embodiment, the drive magnet 17 is magnetized in the optical axis direction, and a magnetic pole of the subject side face 17a and a magnetic pole of the anti-subject side face 17b of the drive magnet 17 are different from each other. Therefore, according to this embodiment, even when an inner diameter of the drive coil 18 which is wound around in an air core shape is set to be small and thereby the drive coil 18 is miniaturized in the optical axis direction and, further, even when a turning angle of the movable body 3 with respect to the fixed body 5 with the right and left direction as an axial direction of turning is large, it is possible to prevent an electromagnetic force acting in an opposite direction to a direction where the movable body 3 is desired to turn with respect to the fixed body 5 from generating between the drive magnet 17 and the drive coil 18.

As a result, in this embodiment, even when a turning angle of the movable body 3 with respect to the fixed body 5 with the front and rear direction as an axial direction of turning becomes large and, even when a turning angle of the movable body 3 with respect to the fixed body 5 with the right and left direction as an axial direction of turning becomes large, the optical unit 1 is able to be miniaturized in the optical axis direction of the camera module 2 while securing a drive force of the first drive mechanism 8 and a drive force of the second drive mechanism 9. In other words, according to this embodiment, even when a turning angle of the movable body 3 with respect to the fixed body 5 becomes large, the optical unit 1 is able to be miniaturized in the optical axis direction of the camera module 2 while securing a drive force of the drive mechanism 7.

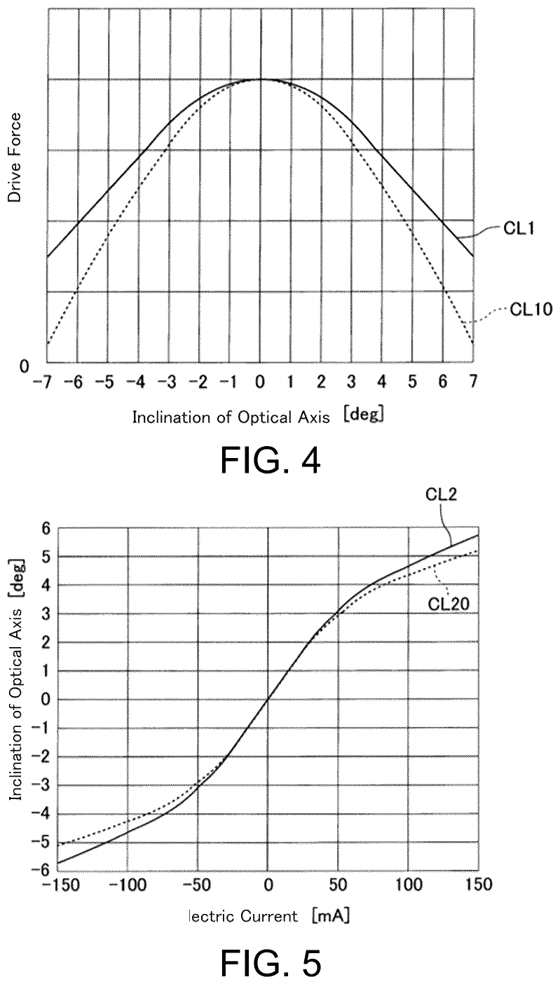

An effect in this embodiment, in other words, an effect that a drive force of the drive mechanism 7 is able to be secured even when a turning angle of the movable body 3 with respect to the fixed body 5 becomes large will be described in detail below based on a simulation result shown in FIG. 4. The curved line “CL1” shown by the solid line in FIG. 4 is a graph showing an example of a variation of a drive force of the first drive mechanism 8 or the second drive mechanism 9 in the simulation when an inclination of the optical axis “L” of the camera module 2 in this embodiment is changed. When the inclination of the optical axis “L” is 0°, the camera module 2 is located at the reference position, and the optical axis direction and the upper and lower direction are coincided with each other.

Further, the curved line “CL10” shown by the broken line in FIG. 4 is a graph showing an example of a variation of a drive force of the drive mechanism 103 in the simulation when an inclination of the optical axis “L10” of the optical module of the optical unit 100 shown in FIGS. 6A and 6B is changed. In the simulation, a constant electric current is supplied to the drive coil 16 or the drive coil 18, and a constant electric current is supplied to the drive coil 106.

As shown in FIG. 4, in the optical unit 1 in this embodiment, in comparison with the optical unit 100 shown in FIGS. 6A and 6B, even when a turning angle of the movable body 3 with respect to the fixed body 5 becomes large and the optical axis “L” of the camera module 2 is largely inclined, a decrease of a drive force of the first drive mechanism 8 or the second drive mechanism 9 is suppressed. In other words, as also clear from the simulation result, in this embodiment, even when a turning angle of the movable body 3 with respect to the fixed body 5 becomes large, a drive force of the drive mechanism 7 is able to be secured.

In this embodiment, the drive magnets 15 and 17 are single-pole magnetized in the optical axis direction. Therefore, according to this embodiment, the drive magnets 15 and 17 is able to be easily manufactured. Accordingly, in this embodiment, a manufacturing cost of the drive magnets 15 and 17 is able to be reduced.

In this embodiment, in a state that the camera module 2 is located at the reference position, when viewed in the right and left direction, a center of the drive magnet 15 and a center of the drive coil 16 are coincided with each other and a width “W1” of the drive magnet 15 in the optical axis direction is smaller than a width “W2” in the upper and lower direction of the drive coil 16. Therefore, according to this embodiment, even when the drive magnet 15 is magnetized in the optical axis direction, in a state that the camera module 2 is located at the reference position, density of magnetic flux passing through the drive coil 16 is able to be increased. Accordingly, in this embodiment, even when the drive magnet 15 is magnetized in the optical axis direction, a drive force of the first drive mechanism 8 is able to be secured when the camera module 2 is located at the reference position.

Similarly, in this embodiment, in a state that the camera module 2 is located at the reference position, when viewed in the front and rear direction, a center of the drive magnet 17 and a center of the drive coil 18 are coincided with each other and a width of the drive magnet 17 in the optical axis direction is smaller than a width in the upper and lower direction of the drive coil 18. Therefore, even when the drive magnet 17 is magnetized in the optical axis direction, a drive force of the second drive mechanism 9 is able to be secured when the camera module 2 is located at the reference position.

As shown in FIG. 4, a drive force of the first drive mechanism 8 or the second drive mechanism 9 when the camera module 2 is located at the reference position (in other words, a drive force of the first drive mechanism 8 or the second drive mechanism 9 when an inclination of the optical axis “L” of the camera module 2 is 0°) is substantially equal to a drive force of the drive mechanism 103 when the optical module is located at the reference position in the optical unit 100 shown in FIGS. 6A and 6B.

In this embodiment, when the camera module 2 is located at the reference position, a thickness “t1” in the right and left direction of the drive magnet 15 is larger than a thickness “t2” in the right and left direction of the drive coil 16. Therefore, according to this embodiment, even when the drive magnet 15 is magnetized in the optical axis direction, density of magnetic flux passing through the drive coil 16 is able to be increased. Accordingly, in this embodiment, a drive force of the first drive mechanism 8 is able to be increased. Similarly, in this embodiment, when the camera module 2 is located at the reference position, a thickness in the front and rear direction of the drive magnet 17 is larger than a thickness in the front and rear direction of the drive coil 18 and thus, when the drive magnet 17 is magnetized in the optical axis direction, density of magnetic flux passing through the drive coil 18 is able to be increased. As a result, a drive force of the second drive mechanism 9 is able to be increased.

In this embodiment, the drive magnet 15 is directly fixed to the holder 11 which is made of resin. Therefore, according to this embodiment, in comparison with a case that the drive magnet 15 is fixed to the holder 11 through a back yoke, density of magnetic flux passing through the drive coil 16 is able to be increased. Accordingly, in this embodiment, a drive force of the first drive mechanism 8 is able to be increased. Similarly, in this embodiment, the drive magnet 17 is directly fixed to the holder 11 made of resin and thus, in comparison with a case that the drive magnet 17 is fixed to the holder 11 through a back yoke, density of magnetic flux passing through the drive coil 18 is able to be increased. Therefore, in this embodiment, a drive force of the second drive mechanism 9 is able to be increased.

In simulation, FIG. 5 shows the curved line “CL2” which is a graph in this embodiment showing an example of a change of an inclination of the optical axis “L” of the camera module 2 when an electric current supplied to the drive coil 16 is varied, and the curved line “CL20” which is a graph showing an example of a change of an inclination of the optical axis “L10” of the optical module when an electric current supplied to the drive coil 106 of the optical unit 100 shown in FIGS. 6A and 6B is varied. As shown in FIG. 5, in the optical unit 1 in this embodiment, in comparison with the optical unit 100, even when an inclination of the optical axis “L” of the camera module 2 becomes large, the optical axis “L” is easily inclined depending on a current supplied to the drive coil 16.

Although the present disclosure has been shown and described with reference to a specific embodiment, various changes and modifications will be apparent to those skilled in the art from the teachings herein.

In the embodiment described above, the first drive mechanism 8 may include two drive magnets 15 and two drive coils 16 which are disposed on both sides in the right and left direction of the holder 11. Similarly, in the embodiment described above, the second drive mechanism 8 may include two drive magnets 17 and two drive coils 18 which are disposed on both sides in the front and rear direction of the holder 11.

In the embodiment described above, a thickness “t1” in the right and left direction of the drive magnet 15 when the camera module 2 is located at the reference position may be the same as a thickness “t2” in the right and left direction of the drive coil 16, or may be thinner than the thickness “t2”. Similarly, a thickness in the front and rear direction of the drive magnet 17 when the camera module 2 is located at the reference position may be the same as a thickness in the front and rear direction of the drive coil 18, or may be thinner than the thickness in the front and rear direction of the drive coil 18. Further, in the embodiment described above, the width “W1” of the drive magnet 15 in the optical axis direction may be the same as the width “W2” in the upper and lower direction of the drive coil 16, or may be wider than the width “W2”. Similarly, a width of the drive magnet 17 in the optical axis direction may be the same as a width in the upper and lower direction of the drive coil 18, or may be wider than a width in the upper and lower direction of the drive coil 18.

In the embodiment described above, the optical unit 1 may be provided with no intermediate member 4. In this case, for example, the optical unit 1 includes a fulcrum part disposed on a lower side with respect to the movable body 3 and a spring member which urges the movable body 3 toward the fulcrum part with respect to the fixed body 5, and the fixed body 5 holds the movable body 3 through the spring member. The spring member is, for example, a plate spring which is provided with a fixed body fixed part which is fixed to the fixed body 5, a movable body fixed part which is fixed to the movable body 3, and a plurality of arm parts which connect the fixed body fixed part with the movable body fixed part. Further, the spring member may be a wire spring.

In the embodiment described above, the optical unit 1 may include a turning mechanism which turns the camera module 2 with respect to the intermediate member 4 with the optical axis “L” of the camera module 2 as a turning center. In this case, the intermediate member 4 includes a first intermediate member and a second intermediate member. The movable body 3 is turnable with respect to the first intermediate member with the optical axis “L” of the camera module 2 as a turning center, and the first intermediate member is turnable with respect to the second intermediate member with the first axial line “L1” as a turning center.

In the embodiment described above, the optical module which is included in the optical unit 1 may be a module other than the camera module 2. For example, the optical module may be a LiDAR (Light Detection and Ranging) scanner which reads a distance to an object by utilizing reflection of a laser light. Further, in the embodiment described above, the drive mechanism 7 may be provided with no first drive mechanism 8 or no second drive mechanism 9. Further, in the embodiment described above, the optical unit 1 may be mounted on various devices other than a portable device.

Embodiments of the present disclosure may be structured as follows.

(1) An optical unit including a movable body having an optical module, a fixed body which holds the movable body, and a drive mechanism for turning the movable body with respect to the fixed body so that an optical axis of the optical module is inclined. The drive mechanism includes a drive magnet which is attached to the movable body and a drive coil which is attached to the fixed body, and the drive magnet and the drive coil face each other in a direction perpendicular to an optical axis direction which is a direction of an optical axis of the optical module when the optical module is located at a predetermined reference position. The drive magnet is magnetized in the optical axis direction, and a magnetic pole of one of faces of the drive magnet in the optical axis direction and a magnetic pole of the other of the faces of the drive magnet in the optical axis direction are different from each other.

(2) The optical unit described in the above-mentioned structure (1), where in a case that a predetermined direction perpendicular to the optical axis direction when the optical module is located at the reference position is defined as a first direction, and a direction perpendicular to the optical axis direction and the first direction when the optical module is located at the reference position is referred to as a second direction, the drive mechanism includes, as the drive magnet, a first drive magnet for turning the movable body with respect to the fixed body with the first direction as an axial direction of turning, and a second drive magnet for turning the movable body with respect to the fixed body with the second direction as an axial direction of turning and, as the drive coil, a first drive coil which is disposed so as to face the first drive magnet in the second direction, and a second drive coil which is disposed so as to face the second drive magnet in the first direction.

(3) The optical unit described in the above-mentioned structure (2), further including an intermediate member which turnably holds the movable body, where the fixed body turnably holds the intermediate member.

(4) The optical unit described in one of the above-mentioned structures (1) through (3), where the optical module is a camera module.

(5) The optical unit described in one of the above-mentioned structures (1) through (3), where in a case that a direction in which the drive magnet and the drive coil face each other when the optical module is located at the reference position is defined as a facing direction, when viewed in the facing direction in a state that the optical module is located at the reference position, a center of the drive magnet and a center of the drive coil are coincided with each other.

(6) The optical unit described in the above-mentioned structure (5), where a width of the drive magnet in the optical axis direction is smaller than a width of the drive coil in the optical axis direction when the optical module is located at the reference position.

(7) The optical unit described in one of the above-mentioned structures (1) through (6), where in a case that a direction in which the drive magnet and the drive coil face each other when the optical module is located at the reference position is defined as a facing direction, a thickness of the drive magnet in the facing direction when the optical module is located at the reference position is larger than a thickness of the drive coil in the facing direction.

(8) The optical unit described in one of the above-mentioned structures (1) through (7), where the movable body includes a holder made of resin to which the optical module is fixed, and the drive magnet is directly fixed to the holder.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An optical unit comprising:
a movable body having an optical module;
a fixed body holding the movable body; and
a drive mechanism structured to turn the movable body with respect to the fixed body so that an optical axis of the optical module is inclined;
wherein the drive mechanism comprises a drive magnet attached to the movable body and a drive coil attached to the fixed body;
the drive magnet and the drive coil face each other in a direction perpendicular to an optical axis direction which is a direction of the optical axis of the optical module when the optical module is located at a predetermined reference position;
the drive magnet is magnetized in the optical axis direction; and
a magnetic pole of one of faces of the drive magnet in the optical axis direction and a magnetic pole of an other of the faces of the drive magnet in the optical axis direction are different from each other.

2. The optical unit according to claim 1, wherein
in a case that a predetermined direction perpendicular to the optical axis direction when the optical module is located at the reference position is defined as a first direction, and a direction perpendicular to the optical axis direction and the first direction when the optical module is located at the reference position is referred to as a second direction,
the drive mechanism comprises:
as the drive magnet, a first drive magnet turning the movable body with respect to the fixed body with the first direction as an axial direction of turning, and a second drive magnet turning the movable body with respect to the fixed body with the second direction as an axial direction of turning, and
as the drive coil, a first drive coil disposed to face the first drive magnet in the second direction, and a second drive coil disposed to face the second drive magnet in the first direction.

3. The optical unit according to claim 2, further comprising an intermediate member turnably holding the movable body,
wherein the fixed body turnably holds the intermediate member.

4. The optical unit according to claim 1, wherein the optical module is a camera module.

5. The optical unit according to claim 1, wherein in a case that a direction in which the drive magnet and the drive coil face each other when the optical module is located at the reference position is defined as a facing direction, when viewed in the facing direction in a state that the optical module is located at the reference position, a center of the drive magnet and a center of the drive coil are coincided with each other.

6. The optical unit according to claim 5, wherein a width of the drive magnet in the optical axis direction is smaller than a width of the drive coil in the optical axis direction when the optical module is located at the reference position.

7. The optical unit according to claim 1, wherein in a case that a direction in which the drive magnet and the drive coil face each other when the optical module is located at the reference position is defined as a facing direction, a thickness of the drive magnet in the facing direction when the optical module is located at the reference position is larger than a thickness of the drive coil in the facing direction.

8. The optical unit according to claim 1, wherein
the movable body comprises a holder made of resin to which the optical module is fixed, and
the drive magnet is directly fixed to the holder.
